(19) United States
(12) Patent Application Publication
(10) Pub. No.: US 2024/0354319 A1
(43) Pub. Date: Oct. 24, 2024

(54) RUNTIME ALIGNMENT OF LANGUAGE MODELS IN CONVERSATIONAL AI SYSTEMS AND APPLICATIONS

(71) Applicant: NVIDIA CORPORATION, Santa Clara, CA (US)

(72) Inventors: Razvan DINU, Voluntari (RO); Jonathan Michael COHEN, Mountain View, CA (US); Christopher Marc PARISIEN, Toronto (CA); Traian-Eugen REBEDEA, Bucharest (RO)

(21) Appl. No.: 18/304,341

(22) Filed: Apr. 20, 2023

(51) Int. Cl. G06F 16/332; G06F 40/35; G06F 40/40

(52) U.S. Cl. CPC G06F 16/3329; G06F 40/35; G06F 40/40

(57) ABSTRACT

Systems and techniques are described related to providing dynamic, configurable, runtime model alignment—in the form of guardrails, in embodiments—for language models (such as LLMs) using a formal modeling language. In at least one embodiment, a dialog flow is determined based on a user input and executed using a language model to generate an output. The dialog flow is specified in a formal modeling programming language and controls output of the language model.

### TECHNICAL FIELD

Embodiments of the present disclosure relate generally to computer science and machine learning and, more specifically, to techniques for performing model alignment for language models using a formal modeling language at runtime.

### BACKGROUND

Language models—such as large language models (LLMs)—have become increasingly capable of performing various natural language processing tasks, such as question answering, sentiment analysis, and entity recognition. LLMs are one type of language model, and LLMs are typically implemented as a neural network that includes a large number (e.g., billions) of parameters that are trained on a large quantity of training data. Once trained, an LLM is oftentimes able to perform—or participate in the performance of—a wide variety of natural language processing tasks, as opposed to smaller language models that are generally trained for a specific or individual task. However, conventional language models, and conventional LLMs in particular, sometimes generate undesired outputs, such as outputs that are of relatively low quality, irrelevant to a user input, contextually inappropriate, factually inaccurate, biased, harmful, and/or do not align with the business goals of an entity.

Constraining an LLM to generate desired outputs, which can include preventing the LLM from generating undesired outputs, is sometimes referred to as model alignment-which may be accomplished, in some instances, using “guardrails.” For example, one conventional approach for constraining an LLM to generate desired outputs is to train the LLM via reinforcement learning using human feedback to previous outputs of the LLM (e.g., feedback labeling whether the output is harmful, accurate, relevant, or not) or feedback that is automatically generated, until the LLM learns to generate desired outputs based on the feedback. One drawback of constraining an LLM to generate desired outputs by training the LLM is that such training can be very computationally expensive and time consuming, and in between model updates and re-training the LLM alignment or embedded guardrails are fixed—e.g., these guardrails cannot be dynamically adjusted at runtime. As such, the LLM must be re-trained each time that the LLM needs to generate new types of desired outputs.

Another conventional approach for constraining an LLM to generate desired outputs (or not to generate undesired outputs) is to perform prompt tuning, such as by providing fixed natural language instructions along with any user input or query in a prompt that is input into the LLM. For example, in response to the user input “is 7901 a prime number?”, a prompt may be generated that includes the user input and the fixed natural language instructions that indicate to the model that the output of the model is not to include, for example, financial advice, information about competitors, inappropriate language, etc. One drawback of constraining an LLM using fixed natural language instructions in a prompt for the LLM is that such prompts are oftentimes ineffective, unreliable, and/or not suitable for the endless possibilities of user inputs or user queries. As a result, prompt tuning must be constantly iterated on to account for each new scenario where the LLM generates an undesired output. In addition, by accounting for numerous scenarios—including those not related to a given or current user query—the prompt may become unnecessarily long, thus requiring additional processing resources, increasing latency, and reducing the ability of the underlying system to perform as effectively at runtime. Further, these extensive prompts may cloud the user input or query, and provide unrelated contextual information that the LLM may rely on when generating a response—thus resulting in less tailored or on-point outputs.

As the foregoing illustrates, what is needed in the art are more effective techniques constraining language models to generate desired outputs.

### BRIEF DESCRIPTION OF DRAWINGS

FIG. 1 illustrates a block diagram of a computing system configured to implement one or more aspects of at least one embodiment;

FIG. 2 is a more detailed illustration of the dialog engine of FIG. 1, according to at least one embodiment;

FIG. 3 illustrates example configuration information that can be used by the dialog engine of FIG. 1, according to at least one embodiment;

FIGS. 4A-4B illustrate an example of the dialog engine of FIG. 1 responding to a greeting, according to at least one embodiment;

FIGS. 5A-5F illustrate an example of the dialog engine of FIG. 1 responding to a math question, according to at least one embodiment;

FIG. 6 illustrates a flow diagram of a process for a dialog engine to respond to user input, according to at least one embodiment;

FIG. 7 is a more detailed illustration of the operation of converting user input into canonical form input in the process of FIG. 6, according to at least one embodiment;

FIG. 8 is a more detailed illustration of the operation of generating a dialog flow in the process of FIG. 6, according to at least one embodiment;

FIG. 9 is a more detailed illustration of the operation of executing a matching or generated dialog flow in the process of FIG. 6, according to at least one embodiment;

FIG. 10 is a more detailed illustration of the operation of converting an output into a canonical form output and executing a matching or generated dialog flow in the process of FIG. 7, according to at least one embodiment;

FIG. 11A illustrates inference and/or training logic, according to at least one embodiment;

FIG. 11B illustrates inference and/or training logic, according to at least one embodiment; and

FIG. 12 illustrates training and deployment of a neural network, according to at least one embodiment.

### DETAILED DESCRIPTION

Embodiments of the present disclosure provide techniques for employing runtime model alignment techniques—such as guardrails—that constrain or guide language models to generate desired outputs using a formal modeling language. In at least one embodiment, a dialog engine guides a language model to generate desired outputs and/or safeguards from undesirable outputs generated using the language model. For example, in response to receiving a user input, the dialog engine converts the user input into a canonical form (e.g., a short description or summarization) input and determines a dialog flow for the canonical form input by either matching the canonical form input to a predefined dialog flow or generating a dialog flow if the canonical form input does not match any predefined dialog flow. Then, the dialog engine executes the matching or generated dialog flow to generate an output. Optionally, the dialog engine can convert the output into a canonical form output, match the canonical form output to another predefined dialog flow for handling outputs or generate another dialog flow if the canonical form output does not match any predefined dialog flow for handling outputs, and then execute such a matching or generated dialog flow to generate an updated output.

The techniques for providing runtime model alignment—such as in the form of guardrails—for language models (e.g., LLMs) have many real-world applications. For example, those techniques may be used in a chat bot, a search engine, a website, a web application, a mobile device application, an in-vehicle or in-machine application, a digital avatar application (e.g., in a talking kiosk), and/or the like.

The above examples are not in any way intended to be limiting. As persons skilled in the art will appreciate, as a general matter, the techniques for providing dynamic, configurable, runtime model alignment or guardrails for language models can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs) that may process text, audio, and/or image data, systems for performing light transport simulation, systems for performing collaborative content creation for 3D assets, systems implemented at least partially using cloud computing resources, and/or other types of systems.

### System Overview

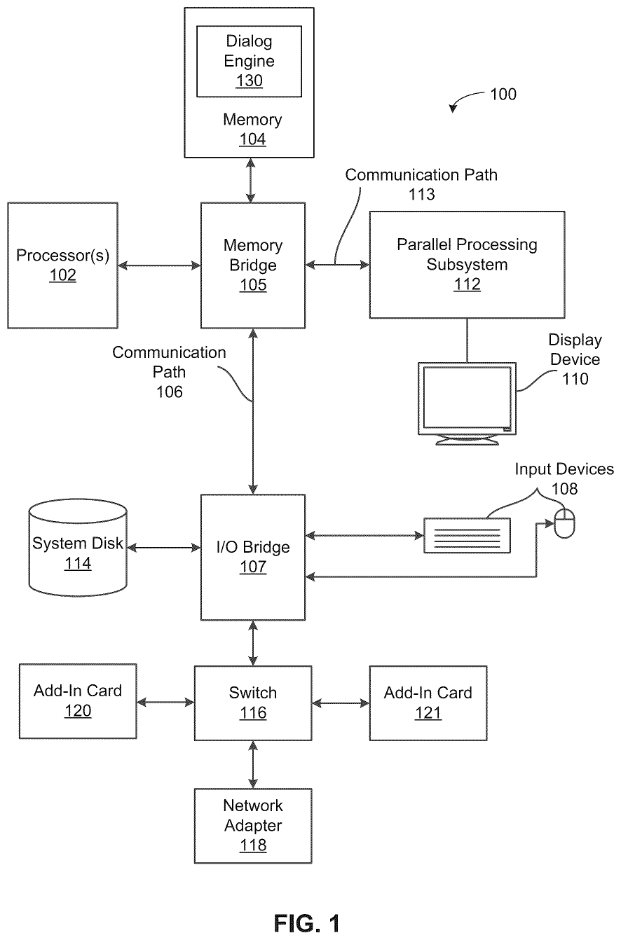

FIG. 1 is a block diagram illustrating a computing system 100 configured to implement one or more aspects of at least one embodiment. In at least one embodiment, the computing system 100 may include any type of computing device, including, without limitation, a server machine, a server platform, a desktop machine, a laptop machine, a hand-held/mobile device, a digital kiosk, an in-vehicle infotainment system, and/or a wearable device. In at least one embodiment, the computing system 100 is a server machine operating in a data center or a cloud computing environment that provides scalable computing resources as a service over a network. In at least one embodiment, the machine learning server 110 can include one or more similar components as the computing system 100.

In various embodiments, the computing system 100 includes, without limitation, processor(s) 102 and memory(ies) 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard, mouse, touch screen, sensor data analysis (e.g., evaluating gestures, speech, or other information about one or more uses in a field of view or sensory field of one or more sensors), and/or the like, and forward the input information to the processor(s) 102 for processing. In at least one embodiment, the computing system 100 may be a server machine in a cloud computing environment. In such embodiments, computing system 100 may not include input devices 108, but may receive equivalent input information by receiving commands (e.g., responsive to one or more inputs from a remote computing device) in the form of messages transmitted over a network and received via the network adapter 118. In at least one embodiment, switch 116 is configured to provide connections between I/O bridge 107 and other components of the computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 comprises a graphics subsystem that delivers pixels to an optional display device 110 that may be any conventional cathode ray tube, liquid crystal display, light-emitting diode display, and/or the like. In such embodiments, the parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

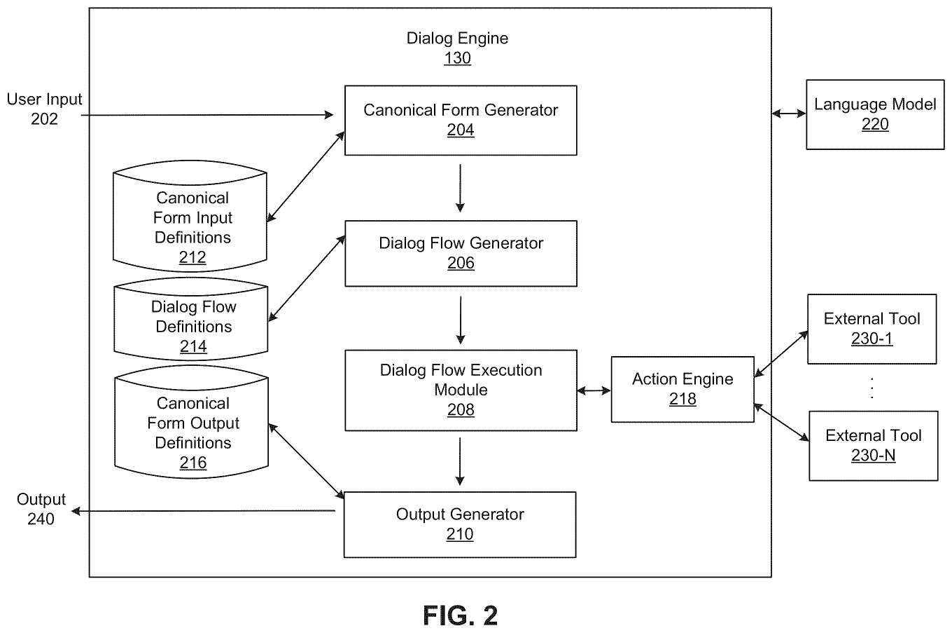

In at least one embodiment, the parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. The memor(ies) 104 include at least one device driver configured to manage the processing operations of the one or more PPUs within parallel processing subsystem 112. In addition, the memor(ies) 104 include a dialog engine 130. The dialog engine 130 can be included in any technically feasible application in at least one embodiment. The dialog engine is described in greater detail herein in conjunction with at least FIGS. 2-10.

In various embodiments, parallel processing subsystem 112 may be integrated with one or more of the other elements of FIG. 2 to form a single system. For example, parallel processing subsystem 112 may be integrated with processor(s) 102 and other connection circuitry on a single chip to form a system on a chip (SoC).

In at least one embodiment, the processor(s) 102 includes a primary processor of the computing system 100, controlling and coordinating operations of other system components. In at least one embodiment, the processor(s) 102 issues commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in at least one embodiment, the memor(ies) 104 may be connected to the processor(s) 102 directly rather than through memory bridge 105, and other devices may communicate with memor(ies) 104 via memory bridge 105 and processor 112. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 2 may not be present. For example, switch 116 may be eliminated, and network adapter 118 and add-in cards 120, 121 would connect directly to I/O bridge 107. Lastly, in certain embodiments, one or more components shown in FIG. 2 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Providing Runtime Guardrails for Language Models Using a Formal Modeling Language

FIG. 2 is a more detailed illustration of the dialog engine 130 of FIG. 1, according to at least one embodiment. As shown, the dialog engine 130 includes a canonical form generator module 204 (“canonical form generator 204”), a dialog flow generator module 206 (“dialog flow generator 206”), a dialog flow execution module 208, an action engine 218, and an output generator module 210 (“output generator 210”). In addition, the dialog engine 130 includes, or has access to, configuration information that includes canonical form input definitions 212, canonical form output definitions 216, and dialog flow definitions 214.

Illustratively, the dialog engine 130 is in communication with a language model 220 and a number of tools 230-1 to 230-N that are external to the dialog engine 130 (referred to herein collectively as external tools 230 and individually as an external tool 230). Any technically feasible language model 220 can be used in at least one embodiment. In at least one embodiment, the language model 220 can be a large language model (LLM) implemented as an artificial neural network that includes a relatively large number (e.g., billions) of parameters and is trained on a relatively large quantity of text data. In at least one embodiment, the language model 220 can execute on the computing system 100, or execute elsewhere and be called (e.g., via one or more application programming interfaces (APIs)) by the dialog engine 130. In at least one embodiment, the dialog engine 130 can be configured using the canonical form input definitions 212, the canonical form output definitions 216, and/or the dialog flow definitions 214 (1) to guide the language model 220 to produce desired (e.g., relatively high quality, relevant, contextually appropriate, and/or aligning with the business goals of an entity) outputs; and/or (2) to safeguard from undesirable (e.g., factually inaccurate, biased, and/or harmful) outputs generated by the language model 220, as discussed in greater detail herein. In at least one embodiment, the canonical form input definitions 212, the canonical form output definitions 216, and/or the dialog flow definitions 214 may be specified in a formal (conversational or natural language) modeling language. In such cases, the formal modeling language can be a programming language that requires a particular syntax defining combinations of symbols that are considered to be correctly structured statements or expressions. For example, in at least one embodiment, the syntax of the formal modeling language can permit definitions of canonical forms associated with user inputs and outputs of a language model; definitions of dialog flows and subflows; entities and variables; sequences of events; structured programming constructs such as if, for, and while constructs; flow branching using when and else when; execute instructions; and/or integration with language models. In at least one embodiment, the formal modeling language can be interpretable by users and/or by some language models (e.g., some LLMs that are multi-modal in text-code). It should be noted that configuration information in the formal modeling language, such as the canonical form input definitions 212, the canonical form output definitions 216, and/or the dialog flow definitions 214, can be independent of any language model (e.g., language model 220) and usable with any suitable language model(s) in at least one embodiment.

In operation, the dialog engine 130 acts as a proxy between users and the language model 220. Illustratively, the dialog engine 130 receives user input 202 (e.g., text (converted from speech, in embodiments), speech, gesture, touch, etc.), and the dialog engine 130 uses the language model 220 and optionally one or more of the external tools 230 (e.g., accessible via one or more APIs) to generate an output 240. The user input 202 can be received in any technically feasible manner in at least one embodiment. For example, in at least one embodiment, the user input 202 can include a textual message that a user enters into a user interface (UI) provided by the dialog engine 130. As another example, in at least one embodiment, the user input 202 can include a textual message that is transmitted by an application to the dialog engine 130.

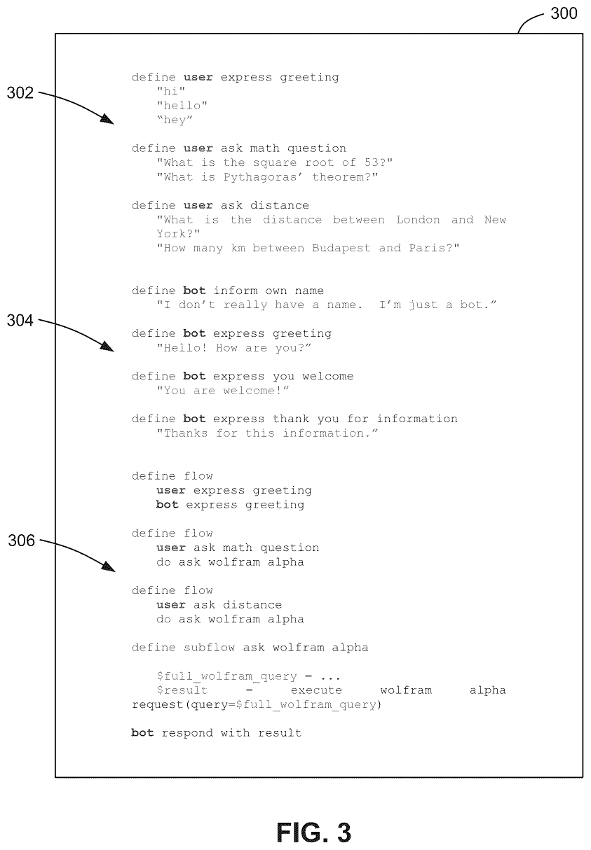

In embodiments, the canonical form generator 204 converts the received user input 202 into a canonical form input. Although the use of canonical forms is described herein, this is not intended to be limiting, and in some embodiments the user input may be used without first being converted to or matched with a canonical form. In at least one embodiment, a “canonical form” can include a constrained semantic representation (e.g., summarization, short description, intent definition) of the natural language of text, such as the text of a user input or text output by a language model. In such cases, the canonical form can paraphrase the text to a standard form. Any suitable canonical forms of user inputs and canonical forms of language model 220 outputs can be used in at least one embodiment. FIG. 3 illustrates example configuration information 300 including definitions of canonical forms that can be used by the canonical form generator 204, according to at least one embodiment. As shown, the configuration information 300 includes definitions of a number of canonical forms including definitions of canonical form inputs 302 and definitions of canonical form outputs 304. In addition, the configuration information 300 includes definitions of a number of dialog flows 306. In at least one embodiment, a dialog flow is a process that can be applied at runtime (e.g., by the dialog engine 130) to control the output of a language model (e.g., language model 220). As discussed in greater detail herein, in at least one embodiment, one or more dialog flows can be used at the ingress to a language model to control whether and/or how the language model is used, and/or what actions are taken, based on user input. Additionally, in at least one embodiment, one or more dialog flows can be used at the egress of a language model to validate or otherwise control the output of the language model.

The configuration information 300 is in a formal (conversational or natural) modeling language. As described, in at least one embodiment, formal modeling language can include a syntax that permits definitions of canonical forms associated with user inputs and outputs of a language model; definitions of dialog flows and subflows; entities and variables; sequences of events; structured programming constructs such as if, for, and while constructs; flow branching using when and else when; execute instructions; and/or integration with language models. Illustratively, each of the definitions of canonical form inputs 302 includes “define user” followed by the canonical form of a user input (e.g., “express greeting,” “ask math question,” and “ask distance”) being defined, as well as examples of user inputs associated with the canonical form input 302 (e.g., “hi,” “hello,” and “hey” are examples user inputs associated with the “express greeting” canonical form input). Each of the definitions of canonical form outputs 304 includes “define bot” followed by the canonical form of an output by the language model 220 (e.g., “inform own name,” “express greeting,” “express you welcome,” and “express thank for information”) being defined, as well as an example of an output by the language model 220 associated with the canonical form output 304 (e.g., “Hello! How are you?” is an example output by the language model 220 that is associated with the “express greeting” canonical form output). Each of the definitions of dialog flows 306 includes “define flow” followed by “user” and a canonical form input, as well as one or more next steps to perform.

More generally, in at least one embodiment, a dialog flow can include a canonical form input or output and one or more associated next steps. For example, a dialog flow may include a canonical form input and a single next step, such as canonical form output to be generated by a language model in response to the canonical form input. As another example, a dialog flow may include a canonical form input or output and multiple next steps expressing a conversation script that should be respected, and the multiple next steps may further include executing actions, branching, and/or variables, which may or may not require interacting with a language model. Illustratively, one of the definitions of dialog flows 306 includes as the canonical form input “express greeting” and as a next step the canonical form output “express greeting.” Another one of the definitions of dialog flows 306 includes as the canonical form input “ask math question” and as a next step “ask wolfram alpha,” which is specified via “do” as an action to be performed by dialog engine 130. In addition, the dialog flows 306 include a subflow for “ask wolfram alpha” that defines multiple next steps to perform, including a query to be generated by the dialog engine 130, execution of the query using WolframAlpha® (e.g., by calling a corresponding API), which is a commercially available computational knowledge engine, and the canonical form output “respond with result.” It should be noted that the configuration information 300 includes a limited number of definitions of canonical form inputs 302, definitions of canonical form outputs 304, and definitions of dialog flows 306. For example, the configuration information 300 may include definitions of a few examples of canonical form inputs, canonical form outputs, and dialog flows that are considered important by a user who created the configuration information 300. As discussed herein, the dialog engine 130 is able to generate other similar canonical form inputs, canonical form outputs, and/or definitions of dialog flows in at least one embodiment. It should also be noted that, because the configuration information 300 is in the formal modeling language, the configuration information 300 can be programmable and interpretable by users.

Although FIG. 3 is described with respect to specific dialog flows for illustrative purposes, any suitable dialog flows can be used in at least one embodiment. As described, in at least one embodiment, one or more dialog flows can be used at the ingress to a language model to control whether and/or how the language model is used, and/or what actions are taken, based on user input. Additionally, in at least one embodiment, one or more dialog flows can be used at the egress of a language model to validate or otherwise control the output of the language model. For example, in at least one embodiment, one or more dialog flows can be used to engage in and/or avoid discussing certain topics, such as to avoid providing financial advice or to avoid discussing subjects unrelated to a particular entity. As another example, in at least one embodiment, one or more dialog flows can be used to cause a language model to follow a certain dialog path, such as a dialog path for authenticating a user. As another example, in at least one embodiment, one or more dialog flows can be used for fact checking, such as to check output of a language model against information obtained by querying a knowledge base and/or a search engine (e.g., by comparing an output against a factual document, such as a user guide or a product specification document). As another example, in at least one embodiment, one or more dialog flows can be used to check programming code generated by a language model, such as testing that the programming code can be executed successfully. As another example, in at least one embodiment, one or more dialog flows can be used to provide additional context to a language model, such as providing instructions for a task associated with user input and/or providing hints associated with an intent of the user. As another example, in at least one embodiment, one or more dialog flows can be used to constrain a language model to generate certain types of outputs, such as to respond to questions in a particular manner. As another example, in at least one embodiment, one or more dialog flows can be used to execute one or more actions and/or make one or more API calls and (optionally) to use results of the action(s) and/or API calls to improve an output of a language model, such as calling a computational knowledge engine that performs mathematical computations to generate a result that can be included in, or used to improve, an output of a language model. As another example, in at least one embodiment, one or more dialog flows can be used to control the style of output generated by a language model, such as to control a personality of output generated by the language model (e.g., by providing example dialog, or example textual outputs, as part of a prompt to the language model, in order to provide examples of a format, style, character, or emotion desired for responses from the dialog system). As another example, in at least one embodiment, one or more dialog flows can be used to provide natural language instructions to a language model, such as to provide natural language instructions to an instruction-tuned LLM. As another example, in at least one embodiment, one or more dialog flows can be used to provide a deny list of certain words and/or phrases that cannot be included in output of a language model. As another example, in at least one embodiment, one or more dialog flows can be used to prevent prompt injection, such as to prevent a user from hijacking a prompt input into a language model. As yet another example, in at least one embodiment, one or more dialog flows can be used to control a language model to format outputs according to a particular format, such as the JSON (JavaScript Object Notation) format.

In at least one embodiment, configuration information that includes definitions of canonical form inputs, canonical form outputs, and/or dialog flows (e.g., configuration information 130) can be provided to the dialog engine 130 in any technically feasible manner. For example, in at least one embodiment, the dialog engine 130 or another application can provide a user interface (UI) (e.g., a web-based UI) and/or an API can be used to specify such configuration information; import and/or customize such configuration information; and/or select to use and/or customize predefined (e.g., commonly used) canonical form inputs, canonical form outputs, and/or dialog flows. As another example, such configuration information can be included in a library that is integrated into an application that includes the dialog engine 130.

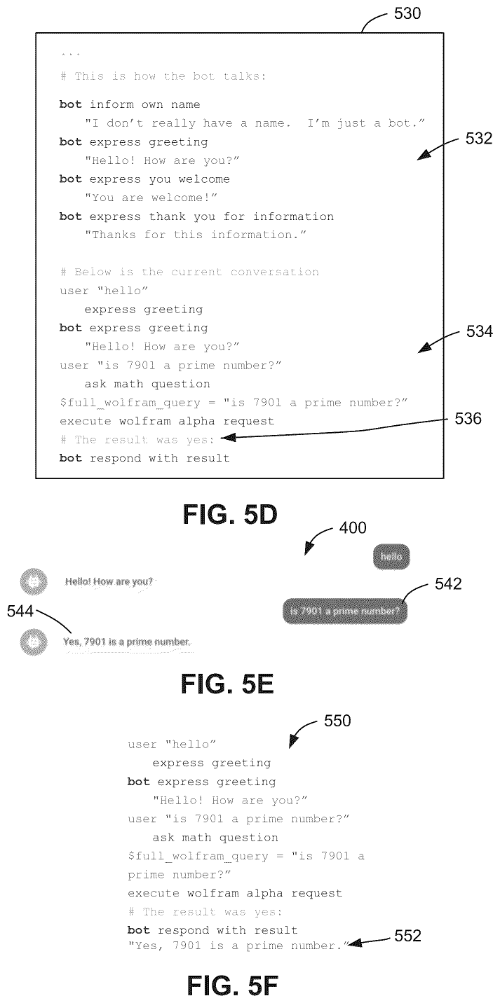

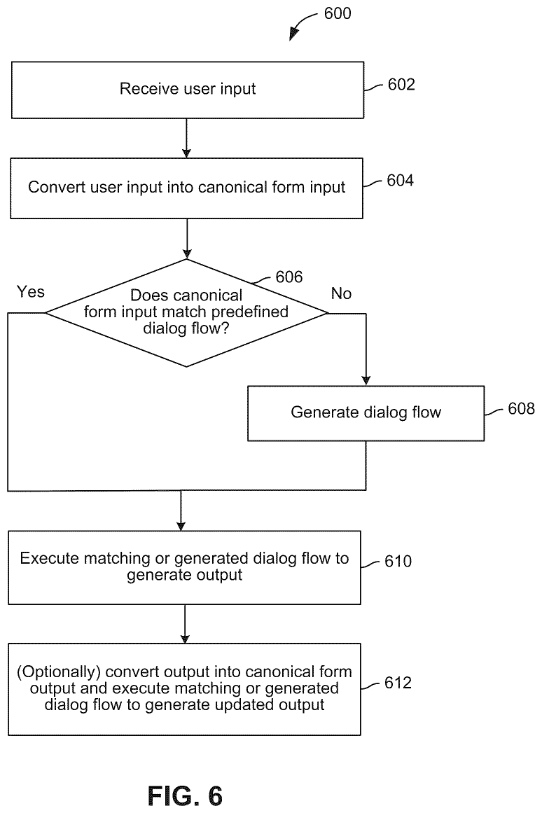

Returning to FIG. 2, in at least one embodiment, the canonical form generator 204 converts the user input 202 into a canonical form input by (1) determining one or more most similar example user inputs in the canonical form input definitions 212 and associated canonical form inputs; and (2) prompting the language model 220 to generate the canonical form input using a few-shot prompt that includes the most similar example user inputs, the corresponding canonical form inputs, and the current conversation (e.g., the dialog history) with the user, as discussed in greater detail herein in conjunction with at least FIGS. 6-7. In such cases, the canonical form generator 204 can determine the number of most similar example user inputs by generating an embedding (e.g., a vector embedding) of the user input in a semantic or latent space, such as by inputting the user input into a sentence transformer or other trained machine learning model that outputs the embedding as a vector, and then comparing the embedding of the user input to embeddings of the example user inputs in the canonical form input definitions 212 to determine one or more similar example user inputs whose embeddings are closest, according to a distance metric, to the embedding of the user in the semantic or latent space. Any technically feasible distance metric can be used in at least one embodiment, including well-known distance metrics. The canonical form generator 204 then generates a few-shot prompt that includes the similar example user inputs, corresponding predefined canonical form inputs, and/or the current conversation, with the few-shot prompt being in the syntax of the formal modeling language. Thereafter, the canonical form generator 204 inputs the few-shot prompt into the language model 220, which outputs a canonical form input. In at least one other embodiment, the canonical form generator 204 can input the user input 202 (and optionally context, such a history of the current conversation) into a trained machine learning model, such as a p-tuned LLM, that was trained to output a canonical form in response to input text, e.g., to translate the input text into a canonical form. In such cases, the trained machine learning model can output a canonical form input when the canonical form generator 204 inputs the user input 202 (and optional context) into the trained machine learning model.

It should be understood that the canonical form input generated by the canonical form generator 204 may, or may not, exactly match one of the canonical form inputs in the canonical form input definitions 212. Returning to the example of FIG. 3, assume the user input is “How are you doing?,” and the canonical form generator 204 determines that the most similar example user inputs are (1) “hi,” “hello,” and “hey” that are associated with the “express greeting” canonical form input; and (2) “what is Pythagoras' theorem?” that is associated with the “ask math question” canonical form input. In such a case, the canonical form generator 204 may prompt the language model 220 to generate a canonical form input using a few-shot prompt that includes the most similar example user inputs, the associated canonical form inputs, and the current conversation with the user. In turn, the language model 220 may respond with a canonical form input that is different from the canonical form inputs defined in the configuration information 300. For example, the language model 220 may output “express greeting question” as the canonical form input, which is different from the canonical form inputs in the canonical form input definitions 212. In at least one embodiment, generated canonical form inputs and/or outputs that are different from predefined canonical form inputs and/or outputs can also be added to configuration information that includes the predefined canonical form inputs and/or outputs via a managed process in which a user is permitted to select which canonical form inputs and/or outputs to add to the configuration information. For example, if a user determines that the canonical form input “express greeting question” is sufficiently common, then the user may add the canonical form input “express greeting question” to the configuration 300 along with an associated example user input “How are you doing?”

In some embodiments, where there is no direct match for a canonical form, the closest canonical form (e.g., in the latent or semantic space) may be selected, and the dialog flow associated with this canonical form may be used. Because the dialog flow may not directly align with the current user input, a language model (e.g., an LLM) may be used to determine an appropriate response from a prompt generated using the user input, the history of the conversation, the closest one or more canonical forms and related dialog flows (e.g., expressed in the natural language modeling language, which may include example bot outputs corresponding to those flows, and/or other example bot outputs), and/or any additional information (e.g., data pulled from one or more API calls, such as to one or more third party services), and the language model may process this generated prompt to output a natural language response that aligns well with desired dialog flows and outputs associated with similar canonical forms (or more generally, with similar user inputs/queries). In such embodiments, where the canonical form matches a predefined canonical form, the flow associated with the matched canonical form may be used. Where the flow does not require interaction with the language model 220, the language model 220 may not be used, and the dialog flow defined by the dialog manager may be followed. Where a canonical form matches, and the dialog flow for the given canonical form includes using the language model 220, a prompt may be generated for the language model 220 using, in non-limiting embodiments, a predefined prompt style associated with the dialog flow for the matched canonical form.

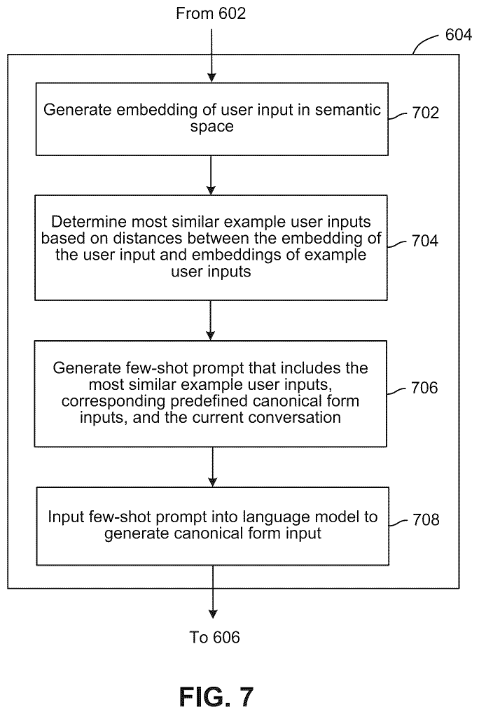

As further examples, given the canonical form input generated by the canonical form generator 204 as input, the dialog flow generator 206 determines a dialog flow for the canonical form input. As described, in at least one embodiment, a dialog flow is a process that can be applied at runtime (e.g., by dialog engine 130) to control the output of a language model (e.g., language model 220). In at least one embodiment, determining the dialog flow includes matching the canonical form input to a dialog flow in the dialog flow definitions 214 or generating a dialog flow if no matching dialog flow exists in the dialog flow definitions 214. As described, one or more of the dialog flow definitions 214 can each include a canonical form input and one or more next steps associated with the canonical form input. In at least one embodiment, the dialog flow generator 206 determines whether any dialog flow in the dialog flow definitions 214 includes a canonical form input that exactly (or within a threshold similarity) matches the canonical form input generated by the canonical form generator 204. As used herein, matching within a threshold similarity can be determined in any technically feasible manner, such as based on a distance between embeddings, via fuzzy matching, etc. In such cases, if no dialog flow in the dialog flow definitions 214 includes a canonical form input that exactly (or within a threshold similarity) matches the canonical form input generated by the canonical form generator 204, then the dialog flow generator 206 generates a dialog flow by (1) determining one or more most similar canonical form inputs from the dialog flows of the dialog flow definitions 214; and (2) prompting the language model 220 to generate the dialog flow using a few-shot prompt that includes the most similar canonical form inputs, the corresponding predefined dialog flows, and/or the current conversation with the user, as discussed in greater detail herein in conjunction with at least FIGS. 6 and 8.

In at least one embodiment, the dialog flow generator 206 can determine the number of most similar canonical form inputs and prompt the language model 220 to generate the dialog flow in a similar manner as the canonical form generator 204 determines the most similar example user inputs and prompts the language model 220 (or another model) to generate a canonical form input, described above, except the dialog flow generator 206 can (1) compare embeddings of the canonical form input to embeddings of canonical form inputs in the dialog flow definitions 214 to determine the most similar canonical form inputs; and (2) generate a few-shot prompt for the language model 220 that includes the most similar canonical form inputs, the corresponding dialog flows in the dialog flow definitions 214, and/or the current conversation with the user. Similar to the discussion above with respect to the canonical form input, given the few-shot prompt generated by the dialog flow generator 206, the language model 220 may respond with a dialog flow that is different from the dialog flows in the dialog flow definitions 214.

In at least one other embodiment, the dialog flow generator 206 can generate a dialog flow by inputting the canonical form input generated by the canonical form generator 204 (and optionally context, such a history of the current conversation) into a trained machine learning model, such as a p-tuned LLM, that was trained to output a dialog flow in response to input text, e.g., to translate the input text into a dialog flow. In such cases, the trained machine learning model can output a dialog flow when the canonical form generator 204 inputs the canonical form input (and optional context) into the trained machine learning model.

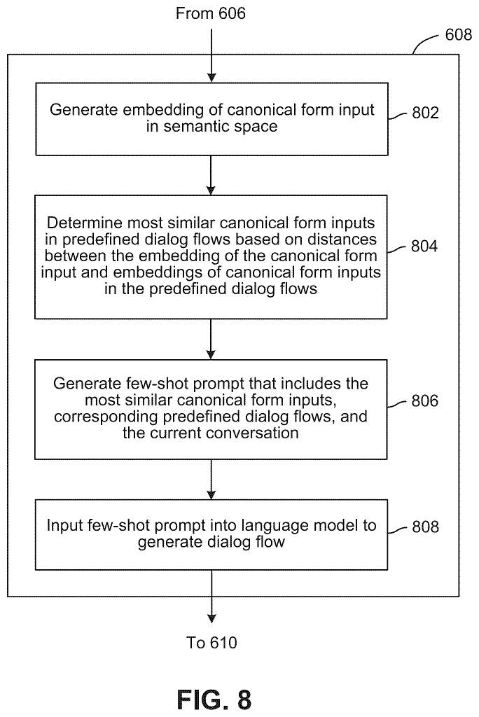

Given the matching dialog flow in the dialog flow definitions 214 or a dialog flow that is generated by the dialog flow generator 206 as input, the dialog flow execution module 208 executes the matching or generated dialog flow to generate an output. In at least one embodiment, executing the matching or generated dialog flow includes executing the one or more next steps included in the matching or generated dialog flow. In such cases, executing the one or more next steps can include (1) determining a context, which can include, e.g., the last user input 202, a full history of the current conversation, information about an application such as application state variables, and/or environmental context such as in a multi-modal application; (2) optionally causing external tool(s) to execute based on the context and/or other parameters to generate an intermediate output; (3) matching (or matching within a threshold similarity) a canonical form output associated with the matching or generated dialog flow to a predefined canonical form output or, if no such match exists, determining one or more most similar predefined canonical form outputs to the canonical form output associated with the matching or generated dialog flow; and (4) outputting an example output associated with a matching predefined canonical form output or, if the canonical form output associated with the matching or generated dialog flow does not match any predefined canonical form output, prompting the language model 220 to generate an output using a few-shot prompt that includes the most similar canonical form outputs, corresponding example outputs, and/or the current conversation with the user, as discussed in greater detail herein in conjunction with at least FIGS. 6 and 9. Any technically feasible external tools can be used in at least one embodiment, and the particular external tool(s) that are used can be specified by the matching or generated dialog flow. Illustratively, the dialog flow execution module 208 is in communication with the action engine 218 that can call one or more of the external tools 230 to execute based on the context and/or other parameters to generate the intermediate output. Examples of external tools 230 that can be used in at least one embodiment include knowledge bases, computational knowledge engines, search engines, automation services, libraries that include functions, etc.

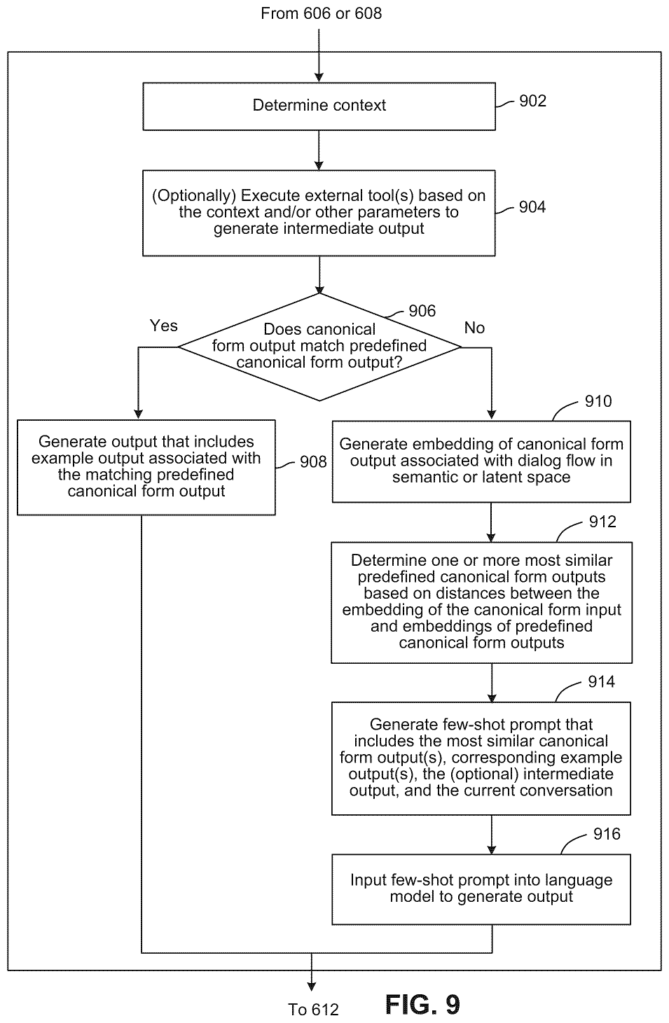

Given the output generated by the dialog flow execution module 208 as input, the output generator 210 generates an output 240, which can be the same as or different from the output generated by the dialog flow execution module 208 in at least one embodiment. In at least one embodiment, the output 240 includes a textual message that can be output to a user in any technically feasible manner in at least one embodiment. For example, in at least one embodiment, the output 240 can include a textual message that the dialog engine 130 displays to a user via a UI. As another example, in at least one embodiment, the output 240 can include a textual message that is transmitted by the dialog engine 130 to an application that transmitted the user input 202 to the dialog engine 130. In addition to the dialog flow that is applied by the dialog flow execution module 208 to guide the language model 220 to produce a desired output, described above, in at least one embodiment, the output generator 210 can optionally use a dialog flow to update the output of the language model 220 in order to control outputs of the language model 220, such as to prevent undesired (e.g., factually inaccurate, biased, and/or harmful) outputs. In such cases, the output generator 210 can convert the output generated by the dialog flow execution module 208 into a canonical form output, determine a dialog flow for handling the canonical form output by matching (or matching within a threshold similarity) the canonical form output to a predefined dialog flow or generating a dialog flow if the canonical form output does not match any predefined dialog flow, and execute the matching or generated dialog flow to generate an updated output, which is the similar to the process discussed above for processing a user input, except the output generated by the dialog flow execution module 208 is being processed instead, as discussed in greater detail herein in conjunction with at least FIGS. 6 and 10.

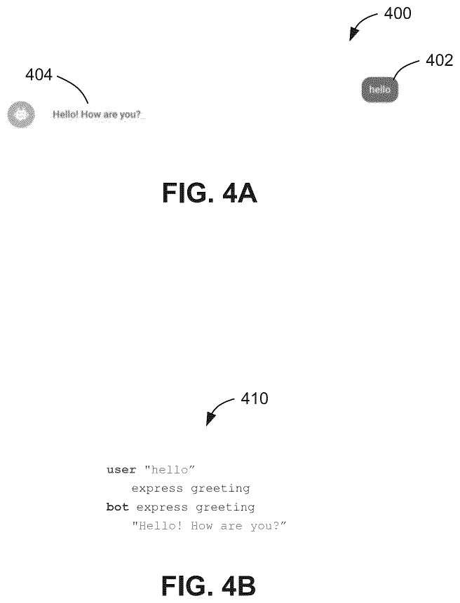

FIGS. 4A-4B illustrate an example of the dialog engine 130 responding to a greeting, according to at least one embodiment. As shown in FIG. 4A, during a dialog 400 between a user and the dialog engine 130, the user inputs a text message “hello” 402, and the dialog engine 130 outputs a text message “Hello! How are you?” 404 in response.

FIG. 4B shows a structured conversation 410 that corresponds to the dialog 400 of FIG. 4A and is in the formal modeling language. As shown, the dialog engine 130 has converted the user input text message “hello” 402 into the canonical form input “express greeting.” In at least one embodiment, the dialog engine 130 can convert the user input text message “hello” 402 into the canonical form input “express greeting” by (1) determining one or more most similar example user inputs in the canonical form input definitions 302 in the configuration information 300 of FIG. 3 based on embeddings of the user input text message 402 and embeddings of the example user inputs, and canonical form inputs associated with the most similar example user inputs; and (2) prompting the language model 220 to generate a canonical form input using a few-shot prompt that includes the most similar example user inputs, the corresponding canonical form inputs, and the current conversation with the user, as discussed in greater detail herein in conjunction with at least FIGS. 6-7. In response to receiving such a few-shot prompt, the language model 220 (and/or another model, such as a prompt or canonical form generation model—e.g., neural network) can output the canonical form input “express greeting.” In at least one embodiment, the language model 220 can create a completion using the formal modeling language that continues the current conversation in the few-shot prompt by, e.g., adding the canonical form input “express greeting” to the current conversation. In at least one other embodiment, the dialog engine 130 can convert the user input text message “hello” 402 into the canonical form input “express greeting” by inputting the user input text message “hello” 402 into a trained machine learning model, such as a p-tuned LLM, that was trained to output a canonical form in response to input text. In such cases, the trained machine learning model can output the canonical form input “express greeting” when the dialog engine 130 inputs the user input text message “hello” 402 into the trained machine learning model.

Because the canonical form input “express greeting” exactly matches the canonical form input of the dialog flow 306 that includes the canonical form input “express greeting” and the canonical form output “express greeting” as a next step, the dialog engine 130 executes the matching dialog flow 306 to generate the output text message “Hello! How are you?” 404. In at least one embodiment, the dialog engine 130 can (1) match (or match within a threshold similarity, such as by matching embeddings of) the canonical form output “express greeting” associated with the matching dialog flow 306 to a predefined canonical form output 304 defined in the configuration information 300 or, if no such match exists, determine one or more most similar predefined canonical form outputs to the canonical form output associated with the matching or generated dialog flow; and (2) output an example output associated with a matching predefined canonical form output or, if the canonical form output “express greeting” associated with the matching dialog flow 306 does not match any predefined canonical form output, prompt the language model 220 to generate an output using a few-shot prompt that includes the most similar canonical form outputs, corresponding example outputs, and/or the current conversation with the user. In this example, the canonical form output “express greeting” in the matching dialog flow 306 exactly matches the predefined canonical form output “express greeting” in the configuration information 300, so the dialog engine 130 can output the example text message “Hello! How are you?” 404 associated with the matching predefined canonical form output “express greeting.” As described, in at least one embodiment, the dialog engine 130 can also optionally use a dialog flow to update the output of the language model 220 in order to control the output, such as to prevent undesired (e.g., inaccurate, biased, and/or harmful) outputs to a user.

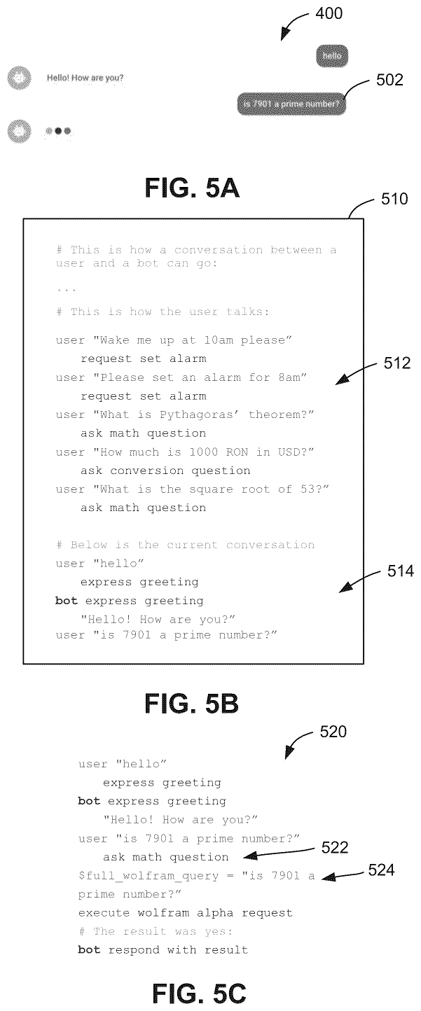

FIGS. 5A-5F illustrate an example of the dialog engine 130 responding to a math question, according to at least one embodiment. As shown in FIG. 5A, the dialog 400 between the user and the dialog engine 130 continues with the user inputting a text message “is 7901 a prime number?” 502.

Similar to the discussion herein in conjunction with FIG. 4B, in at least one embodiment, the dialog engine 130 can convert the user input text message “is 7901 a prime number?” 502 into a canonical form input by (1) determining one or more most similar example user inputs in the canonical form input definitions 302 in the configuration information 300 of FIG. 3 based on embeddings of the user input text message 502 and embeddings of the example user inputs, and canonical form inputs associated with the most similar example user inputs; and (2) prompting the language model 220 to generate a canonical form input using a few-shot prompt that includes the most similar example user inputs, the corresponding canonical form inputs, and the current conversation. FIG. 5B illustrates an example of such a few-shot prompt 510. As shown, the prompt 510 includes five most similar examples 512 of user input that are expressed in the syntax of the formal modeling language as “user ‘Wake me up at 10 am please’,” “user ‘Please set an alarm 8 am’,” “user ‘What is Pythagoras's theorem?’,” “user ‘How much is 1000 RON in USD’,” and “user ‘What is the square root of 53?’,” as well as associated canonical form inputs “request set alarm,” “request set alarm,” “ask math question,” “ask conversion question,” and “ask math question,” respectively. In at least one embodiment, any suitable number of most similar examples and associated canonical form inputs can be listed in any technically feasible order (e.g., most similar to least similar) in the few-shot prompt that the dialog engine 130 generates. Illustratively, the prompt 510 also includes the current conversation 514 (e.g., the dialog history) expressed in the syntax of the formal modeling language.

In response to receiving the prompt 510, the language model 220 (and/or another model) can output the canonical form input “ask math question.” In at least one embodiment, the language model 220 can create a completion using the formal modeling language that continues the current conversation in the prompt 510 by, e.g., adding the canonical form input “ask math question” to the current conversation. In at least one embodiment, the language model 220 (and/or another model) can take as input a few-shot prompt for generating a canonical form input, such as the prompt 510, and output a canonical form input, because the language model 220 can understand the syntax of the formal modeling language in the few-shot prompt. For example, in at least one embodiment, the language model 220 is able to understand the syntax of the formal modeling language because the language model 220 was trained using text data that includes code in one or more programming languages.

In at least one other embodiment, the dialog engine 130 can convert the user input text message “is 7901 a prime number?” 502 into the canonical form input “ask math question” by inputting the user input text message “is 7901 a prime number?” 502 (and optionally context, such a history of the current conversation) into a trained machine learning model, such as a p-tuned LLM, that was trained to output a canonical form in response to input text. In such cases, the trained machine learning model can output the canonical form input “ask math question” when the dialog engine 130 inputs the user input text message “is 7901 a prime number?” 502 into the trained machine learning model.

FIG. 5C shows a structured conversation 520 that corresponds to the dialog 400 of FIG. 5A and is in the formal modeling language. As shown, in response to the user input “is 7901 a prime number?”, the dialog engine 130 has generated the canonical form input “ask math question” 522 according to the process described above in conjunction with FIG. 5B. In addition, the dialog engine 130 has matched the canonical form input “ask math question” 522 to a dialog flow 306 in the configuration information 300 that includes the canonical form input “ask math question” and the next step “do ask wolfram alpha,” and the dialog engine 130 executes the matching dialog flow 306, which includes performing the subflow ask wolfram alpha defined in the configuration information 300. Assume the dialog engine 130 could not match the canonical form input “ask math question” 522 to any predefined dialog flow in the configuration information 300 (or could not match within a threshold similarity), then in at least one embodiment, the dialog engine 130 may generate a dialog flow as described herein in conjunction with at least FIGS. 2, 6, and 8. Illustratively, the dialog engine 130 executes the next step of “do ask wolfram alpha” in the matching dialog flow 306 by (1) determining a context, which in this example is the last user input text message “is 7901 a prime number?”; (2) generating the query “$full_wolfram_query=‘is 7901 a prime number?’” based on the context and causing the computational knowledge engine WolframAlpha® to execute the query (e.g., by calling an associated API), which returns the result yes; and (3) generating an output using the language model 220 based on the returned result.

In at least one embodiment, the dialog engine 130 generates the output by (1) matching (or matching within a threshold similarity) the canonical form output “respond with result” associated with the matching dialog flow 306 to a predefined canonical form output 304 defined in the configuration information 300 or, if no such match exists, determining one or more most similar canonical form outputs defined 304 in the configuration information 300 to the canonical form output “respond with result” in the “ask wolfram alpha” subflow based on a comparison of embeddings of such canonical form outputs; and (2) outputting an example output associated with a matching predefined canonical form output 304 or, if the canonical form output “respond with result” associated with the matching dialog flow 306 does not match any predefined canonical form output 304, prompting the language model 220 to generate an output using a few-shot prompt that includes the most similar canonical form outputs, corresponding example outputs, dialog flow examples, the result returned by WolframAlpha®, and/or the current conversation with the user.

FIG. 5D illustrates an example of a few-shot prompt 530 that is generated because the canonical form output “respond with result” associated with the matching dialog flow 306 does not match any predefined canonical form output 304 in the configuration information 300. As shown, the prompt 530 includes four most similar canonical form outputs 532 that are expressed in the syntax of the formal modeling language as “bot ‘inform own name’,” “bot ‘express greeting’,” “bot ‘express you welcome’,” and “bot ‘thank you for information’,” as well as associated example language model outputs “I don't really have a name. I'm just a bot.”, “Hello! How are you?”, “You are welcome!”, and “Thanks for this information.”, respectively. In at least one embodiment, any suitable number of most similar canonical form outputs and associated examples can be listed in any technically feasible order (e.g., most similar to least similar) in the few-shot prompt that the dialog engine 130 generates. Illustratively, the prompt 530 also includes the current conversation 534 and an indication 536 of the result returned by the WolframAlpha® engine, expressed in the syntax of the formal language model. In response to receiving the prompt 530, the language model 220 can output the response “Yes, 7901 is a prime number.” Given the prompt 530, in at least one embodiment, the language model 220 can create a completion using the formal modeling language that continues the current conversation 530 by, e.g., adding the output “Yes, 7901 is a prime number” to the current conversation 530.

FIG. 5E shows the dialog 400 between the user and the dialog engine 130 continues with the dialog engine 130 outputting the response of the language model 220 as the text message “Yes, 7901 is a prime number.” 544 below the user input text message “is 7901 a prime number?” 502. Although the output of the language model 220 is directly output in the example of FIG. 5E, in at least one embodiment, the dialog engine 130 can optionally use a dialog flow to update the output of the language model 220 in order to control the output (e.g., to prevent undesired outputs to a user), similar to the discussion herein in conjunction with at least FIG. 4B.

FIG. 5F shows a structured conversation 550 that corresponds to the dialog 400 of FIG. 5E and is in the formal modeling language. As shown, the structure conversation 550 adds to the structured conversation 520, described herein in conjunction with FIG. 5C, the output text message “Yes, 7901 is a prime number.” 552.

FIG. 6 illustrates a flow diagram of a process 600 for a dialog engine to respond to user input, according to at least one embodiment. Although the process is described in conjunction with the system of FIG. 1, persons skilled in the art will understand that any system configured to perform the process in any order falls within the scope of the present embodiments.

As shown, the process 600 begins at operation 602, where the dialog engine 130 receives user input. In at least one embodiment, the user input includes a textual message (which may be converted from speech and/or determined from gestures or tactile inputs in some embodiments). In some embodiments, the system may process audio, image, sensor, and/or other data types, in addition or alternatively to textual data. In at least one embodiment, the dialog engine 130 can receive the user input in any technically feasible manner, such as via a UI provided by the dialog engine 130 or from another application that transmits the user input to the dialog engine 130.

At operation 604, the dialog engine 130 converts the user input into a canonical form input. In at least one embodiment, the dialog engine 130 converts the user input into the canonical form input by (1) determining one or more most similar example user inputs and associated canonical form inputs; and (2) prompting the language model 220 (and/or another model) to generate the canonical form input using a few-shot prompt that includes the most similar example user inputs, the corresponding canonical form inputs, and/or the current conversation with the user, as discussed in greater detail herein in conjunction with at least FIG. 7. In at least one other embodiment, the dialog engine 130 can convert the user input into a canonical form input by inputting the user input and optionally context, such a history of the current conversation, into a trained machine learning model, such as a p-tuned LLM, that was trained to output a canonical form in response to input text.

At operation 606, the dialog engine 130 determines whether the canonical form input matches a predefined dialog flow. As described, in at least one embodiment, one or more predefined dialog flows can each include a canonical form input and one or more next steps associated with the canonical form input. In such cases, the dialog engine 130 determines at operation 606 whether any predefined dialog flow includes a canonical form input that exactly (or within a threshold similarity) matches the canonical form input generated at operation 604.

If the dialog engine 130 determines at operation 606 that the canonical form input does not match (or does not match within a threshold similarity) a predefined dialog flow, then at operation 608, the dialog engine 130 generates a dialog flow. In at least one embodiment, the dialog engine 130 generates the dialog flow by (1) determining one or more most similar canonical form inputs in predefined dialog flows; and (2) prompting the language model 220 to generate the dialog flow using a few-shot prompt that includes the most similar canonical form inputs, the corresponding predefined dialog flows, and/or the current conversation with the user, as discussed in greater detail herein in conjunction with at least FIG. 8. In at least one other embodiment, the dialog flow generator 206 can generate a dialog flow by inputting input the canonical form input into a trained machine learning model, such as a p-tuned LLM, that was trained to output a dialog flow in response to input text, e.g., to translate the input text into a dialog flow. In such cases, the trained machine learning model can output a dialog flow when the dialog engine 130 inputs the canonical form input (and optional context) into the trained machine learning model.

After the dialog engine 130 generates the dialog flow at operation 608, or if the dialog engine 130 determines at operation 606 that the canonical form input matches (or matches within a threshold similarity) a predefined dialog flow, the process 600 continues to operation 610, where the dialog engine 130 executes the matching or generated dialog flow to generate an output. In at least one embodiment, executing the matching or generated dialog flow includes executing the one or more next steps included in the matching or generated dialog flow. In such cases, executing the one or more next steps can include (1) determining a context, which can include, e.g., the last user input, a full history of the current conversation, information about an application such as application state variables, and/or environmental context such as in a multi-modal application; (2) optionally causing external tool(s) to execute based on the context and/or other parameters to generate an intermediate output; (3) matching (or matching within a threshold similarity) a canonical form output associated with the matching or generated dialog flow to a predefined canonical form output or, if no such match exists, determining one or more most similar predefined canonical form outputs to the canonical form output associated with the matching or generated dialog flow; and (4) outputting an example output associated with a matching predefined canonical form output or, if the canonical form output associated with the matching or generated dialog flow does not match (or match within a threshold similarity) any predefined canonical form output, prompting the language model 220 to generate an output using a few-shot prompt that includes the most similar canonical form outputs, corresponding example outputs, and/or the current conversation with the user, as discussed in greater detail herein in conjunction with at least FIG. 9.

At operation 612, the dialog engine 130 (optionally) converts the output into a canonical form output and executes a predefined dialog flow that matches the canonical form output, or a dialog flow generated for the canonical form output, to generate an updated output. In at least one embodiment, the dialog engine 130 can convert the output into the canonical form output, determine whether the canonical form output matches (or matches within a threshold similarity) a predefined dialog flow for handling outputs, generate a dialog flow if the canonical form output does not match any predefined dialog flow, and execute the matching or generated dialog flow to generate the updated output, as discussed in greater detail herein in conjunction with at least FIG. 10.

FIG. 7 is a more detailed illustration of the operation 604 of converting user input into canonical form input in the process 600 of FIG. 6, according to at least one embodiment. Although the operation is described in conjunction with the system of FIG. 1, persons skilled in the art will understand that any system configured to perform the operation in any order falls within the scope of the present embodiments.

As shown, at operation 702, the dialog engine 130 generates an embedding of the user input in a semantic or latent space. The dialog engine 130 can generate the embedding (e.g., a vector embedding) of the user input in any technically feasible manner in at least one embodiment. In at least one embodiment, the dialog engine 130 can input the user input into a sentence transformer model or other trained machine learning model that outputs the embedding as a vector.

At operation 704, the dialog engine 130 determines one or more most similar example user inputs based on distances between the embedding of the user input and embeddings of example user inputs. As described, in at least one embodiment, a user can define any number of canonical form inputs and provide example user inputs that are associated with the canonical forms. In such cases, the dialog engine 130 compares the embedding of the user input to embeddings of the example user inputs associated with the predefined canonical form inputs to determine one or more most similar example user inputs whose embeddings are closest in distance, in the semantic or latent space, to the embedding of the user input. In at least one embodiment, any suitable number of most similar example user inputs can be determined at operation 704.

At operation 706, the dialog engine 130 generates a few-shot prompt that includes the most similar example user inputs, corresponding predefined canonical form inputs, and/or the current conversation. In at least one embodiment, the similar example user inputs, corresponding predefined canonical form inputs, and/or current conversation can be expressed in the syntax of a formal modeling language in the few-shot prompt. An example of such a few-shot prompt is described herein in conjunction with at least FIG. 5B.

At operation 708, the dialog engine 130 inputs the few-shot prompt into the language model 220 (and/or another language model) to generate a canonical form input. As described, in at least one embodiment, the language model 220 takes as input the few-shot prompt and outputs the canonical form input, because the language model 220 is able to understand the syntax of the formal modeling language in the few-shot prompt and the language model 220 can create a completion using the formal modeling language that continues the current conversation by adding the canonical form input to the current conversation.

FIG. 8 is a more detailed illustration of the operation 608 of generating a dialog flow in the process 600 of FIG. 6, according to at least one embodiment. Although the operation is described in conjunction with the system of FIG. 1, persons skilled in the art will understand that any system configured to perform the operation in any order falls within the scope of the present embodiments.

As shown, at operation 802, the dialog engine 130 generates an embedding of the canonical form input, which was generated at operation 604, in a semantic or latent space. Similar to operation 702, the dialog engine 130 can generate the embedding of the canonical form input in any technically feasible manner in at least one embodiment, such as by inputting the canonical form input into a sentence transformer model or other trained machine learning model that outputs the embedding as a vector.

At operation 804, the dialog engine 130 determines one or more most similar canonical form inputs in predefined dialog flows based on distances between the embedding of the canonical form input and embeddings of canonical form inputs in the predefined dialog flows. As described, in at least one embodiment, a user can define any number of dialog flows that each include a canonical form input and one or more associated next steps. In such cases, the dialog engine 130 compares the embedding of the canonical form input to embeddings of the canonical form inputs in the predefined dialog flows to determine one or more most similar canonical form inputs in the predefined dialog flows whose embeddings are closest in distance, in the semantic or latent space, to the embedding of the canonical form input. In at least one embodiment, any suitable number of most similar canonical form inputs in predefined dialog flows can be determined at operation 804.

At operation 806, the dialog engine 130 generates a few-shot prompt that includes the most similar canonical form inputs, corresponding predefined dialog flows, and/or the current conversation. Similar to operation 706, in at least one embodiment, the similar canonical form inputs, corresponding predefined dialog flows, and current conversation can be expressed in the syntax of a formal modeling language in the few-shot prompt.

At operation 808, the dialog engine 130 inputs the few-shot prompt into the language model 220 to generate (at least a portion of) a dialog flow. Similar to operation 708, in at least one embodiment, the language model 220 takes as input the few-shot prompt and outputs one or more next steps of a dialog flow associated with the canonical form input, because the language model 220 is able to understand the syntax of the formal modeling language in the few-shot prompt and the language model 220 can create a completion using the formal modeling language that continues the current conversation by adding the dialog flow to the current conversation. For example, in at least one embodiment, the language model 220 can add the one or more next steps to the canonical form input to in the current conversation of the few-shot prompt to generate a dialog flow that includes the canonical form input and the one or more next steps.

FIG. 9 is a more detailed illustration of the operation 610 of executing a matching or generated dialog flow in the process 600 of FIG. 6, according to at least one embodiment. Although the operation is described in conjunction with the system of FIG. 1, persons skilled in the art will understand that any system configured to perform the operation in any order falls within the scope of the present embodiments.

As shown, at operation 902, the dialog engine 130 determines a context. For example, in at least one embodiment, the context can include the user input received at operation 602, a full history of the current conversation, information about an application such as application state variables, and/or environmental context such as in a multi-modal application.

At operation 904, the dialog engine 130 (optionally) causes one or more external tools to execute based on the context and/or other parameters to generate an intermediate output. As described, the external tool(s) are external to the dialog engine 130, and the external tool(s) can run on computing system 100 and/or elsewhere in at least one embodiment. Examples of external tools that can be used in at least one embodiment include knowledge bases, computational knowledge engines, search engines, automation services, etc. In at least one embodiment, the dialog engine 130 can make API calls to, or otherwise access, one or more external tools to cause those tool(s) to execute based on the context and/or other parameters, and the external tool(s) can return the intermediate output to the dialog engine 130. An example of querying a computational knowledge engine to answer a math question is described herein in conjunction with at least FIGS. 5E-5F.

At operation 906, the dialog engine 130 determines whether the canonical form output associated with the matching or predefined dialog flow matches (or matches within a threshold similarity) a predefined canonical form output. If the canonical form output associated with the matching or predefined dialog flow matches a predefined canonical form output, then at operation 908, the dialog engine 130 generates an output that includes an example output associated with the matching predefined canonical form output.

On the other hand, if the canonical form output associated with the matching or predefined dialog flow does not match any predefined canonical form output, then the process 600 continues to operation 910, where the dialog engine 130 generates an embedding, in a semantic or latent space, of a canonical form output associated with the matching or predefined dialog flow. Similar to operation 702, the dialog engine 130 can generate the embedding of the canonical form output in any technically feasible manner in at least one embodiment, such as by inputting the canonical form output into a sentence transformer model or other trained machine learning model that outputs the embedding as a vector.

At operation 912, the dialog engine 130 determines one or more most similar predefined canonical form outputs based on distances between the embedding of the canonical form input and the embeddings of predefined canonical form outputs. As described, in at least one embodiment, a user can define any number of canonical form outputs and provide associated examples of language model outputs. In such cases, the dialog engine 130 compares the embedding of the canonical form outputs to embeddings of the canonical form outputs to determine one or more most similar canonical form outputs whose embeddings are closest in distance, in the semantic or latent space, to the embedding of the canonical form output. In at least one embodiment, any suitable number of most similar canonical form outputs can be determined at operation 912.

At operation 914, the dialog engine 130 generates a few-shot prompt that includes the most similar canonical form output(s), corresponding example output(s), the (optional) intermediate output (or portion(s) thereof), and/or the current conversation with the user. Similar to operation 706, in at least one embodiment, the most similar canonical form output(s), corresponding example output(s), the (optional) intermediate output (or portion(s) thereof), and the current conversation with the user can be expressed in the syntax of a formal modeling language in the few-shot prompt. In some embodiments, retrieval augmentation may be used to retrieve or pull in additional information from one or more additional sources to include in the prompt to the language model 220. In such examples, the information retrieved may be included in a particular dialog flow associated with a particular canonical form, or may be determined based on the user input.

At operation 916, the dialog engine 130 inputs the few-shot prompt into the language model 220 to generate an output. Similar to operation 708, in at least one embodiment, the language model 220 takes as input the few-shot prompt and generates an output, which can be in the form of a textual message, because the language model 220 is able to understand the syntax of the formal modeling language in the few-shot prompt and the language model 220 can create a completion using the formal modeling language that continues the current conversation by adding the output to the current conversation. Where the dialog engine is being used in conjunction with a spoken word, digital avatar, or audio based experience, the textual output of the system may be converted to speech—e.g., using a text to speech algorithm(s)—and then may be output in the form of speech. In some examples, such as where the system includes an audio and/or display element, the textual outputs of the system may be displayed, output in the form of audio, and/or used to animate one or more digital avatars or persons. For example, where the system is used along with a digital avatar at a talking kiosk or in an in-vehicle infotainment system, the text output corresponding to the bot or the avatar may be used to animate (e.g., lips, eyes, gestures, head/body movement, etc.) the avatar in sync with the current conversation.

FIG. 10 is a more detailed illustration of the operation 612 of converting an output into canonical form output and executing a matching or generated dialog flow in the process 600 of FIG. 7, according to at least one embodiment. Although the operation is described in conjunction with the system of FIG. 1, persons skilled in the art will understand that any system configured to perform the operation in any order falls within the scope of the present embodiments.

As shown, at operation 1002, the dialog engine 130 converts the output generated at the operation 610 into a canonical form output. Operation 1002 is similar to operation 602, except an output of the language model 220 is being converted to a canonical form output, rather than a user input being converted to a canonical form input. In at least one embodiment, the dialog engine 130 converts the output into the canonical form output by (1) determining one or more most similar example outputs and corresponding canonical form outputs; and (2) prompting the language model 220 or another model (e.g., a canonical form generation model) to generate the canonical form output using a few-shot prompt that includes the most similar example outputs, the corresponding canonical form outputs, and/or the current conversation with the user. In at least one other embodiment, the dialog engine 130 can convert the output into the canonical form output by inputting the output and optionally context, such a history of the current conversation, into a trained machine learning model, such as a p-tuned LLM, that was trained to output a canonical form in response to input text.

At operation 1004, the dialog engine 130 determines whether the canonical form output matches a predefined dialog flow. Operation 1004 is similar to operation 606, except the predefined dialog flows that the canonical form output is compared to each include a canonical form output and one or more next steps associated with the canonical form output. In at least one embodiment, the dialog engine 130 determines at operation 1004 whether any predefined dialog flow includes a canonical form output that exactly (or within a threshold similarity) matches the canonical form output generated at operation 1002.

If the dialog engine 130 determines that the canonical form output does not match (or does not match within a threshold similarity) any predefined dialog flow, then at operation 1006, the dialog engine 130 generates a dialog flow. In at least one embodiment, the dialog engine 130 generates the dialog flow by (1) determining one or more most similar canonical form outputs in predefined dialog flows that each include a canonical form output and one or more next steps; and (2) prompting the language model 220 to generate the dialog flow using a few-shot prompt that includes the most similar canonical form outputs, the corresponding predefined dialog flows, and the current conversation with the user.

After the dialog engine 130 generates the dialog flow at operation 1006, or if the dialog engine 130 determines at operation 1004 that the canonical form output matches (or matches within a threshold similarity) a predefined dialog flow, the process 600 continues to operation 1008, where the dialog engine 130 executes the matching or generated dialog flow to generate an updated output. Similar to operation 610, in at least one embodiment, executing the matching or generated dialog flow includes executing the one or more next steps included in the matching or generated dialog flow. In such cases, the one or more next steps can include performing any technically feasible action or actions, such as determining a context and optionally causing external tool(s) to execute based on the context and/or other parameters. For example, in at least one embodiment, the action(s) and/or external tools can be used to validate the output generated at the process 610 and/or otherwise control the output, such as preventing undesired outputs from being presented to a user. In at least one embodiment, the action(s) and/or external tools can use the language model 220. For example, assume the matching or generated dialog flow is used to correct factually inaccurate outputs. In such a case, the matching or generated dialog flow may cause the dialog engine 130 to, e.g., query an external knowledge base or search engine to obtain information used to check the factual accuracy of an output and, if the output is not factually accurate, prompt the language model 220 to generate an updated output based on the information from the external knowledge base or search engine.

In sum, techniques are disclosed for employing runtime model alignment techniques-such as guardrails—that constrain or guide language models to generate desired outputs using a formal modeling language (and a dialog manager or engine that executes the same. In at least one embodiment, a dialog engine guides a language model to generate desired outputs and/or safeguards from undesirable outputs generated using the language model. For example, in response to receiving a user input, the dialog engine converts the user input into a canonical form (e.g., a short description or summarization) input and determines a dialog flow for the canonical form input by either matching the canonical form input to a predefined dialog flow or generating a dialog flow if the canonical form input does not match any predefined dialog flow. Then, the dialog engine executes the matching or generated dialog flow to generate an output. Optionally, the dialog engine can convert the output into a canonical form output, match the canonical form output to another predefined dialog flow for handling outputs or generate another dialog flow if the canonical form output does not match any predefined dialog flow for handling outputs, and then execute such a matching or generated dialog flow to generate an updated output.

At least one technical advantage of the disclosed techniques relative to prior solutions is that the disclosed techniques can be used to control the output of a language model at runtime, without requiring the language model to be trained or re-trained using human feedback to previous outputs of the language model or automatically generated feedback (although the disclosed techniques can also be used with a trained or re-trained language model). In addition, the disclosed techniques can be more effective and/or reliable at constraining language models to generate desired outputs than some conventional techniques, such as inputting a prompt that includes natural language instructions into a language model. These technical advantages represent one or more technological improvements over prior art approaches.

### Inference and Training Logic

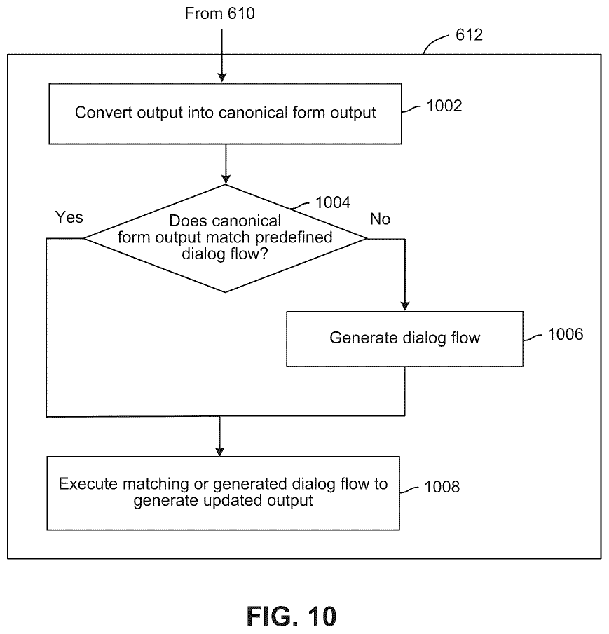

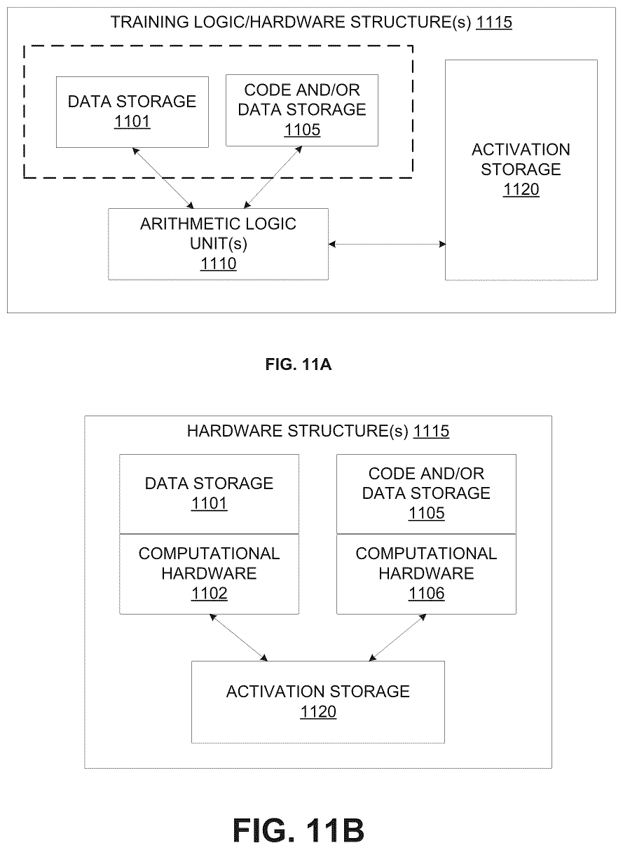

FIG. 11A illustrates inference and/or training logic 1115 used to perform inferencing and/or training operations associated with one or more embodiments. Details regarding inference and/or training logic 1115 are provided herein in conjunction with at least FIGS. 11A and/or 11B.

In at least one embodiment, inference and/or training logic 1115 may include, without limitation, code and/or data storage 1101 to store forward and/or output weight and/or input/output data, and/or other parameters to configure neurons or layers of a neural network trained and/or used for inferencing in aspects of one or more embodiments. In at least one embodiment, training logic 1115 may include, or be coupled to code and/or data storage 1101 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 1101 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1101 may be included with other on-chip or off-chip data storage, including a processor's L1, L2, or L3 cache or system memory.

In at least one embodiment, any portion of code and/or data storage 1101 may be internal or external to one or more processors or other hardware logic devices or circuits. In at least one embodiment, code and/or code and/or data storage 1101 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 1101 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1115 may include, without limitation, a code and/or data storage 1105 to store backward and/or output weight and/or input/output data corresponding to neurons or layers of a neural network trained and/or used for inferencing in aspects of one or more embodiments. In at least one embodiment, code and/or data storage 1105 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1115 may include, or be coupled to code and/or data storage 1105 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 1105 may be included with other on-chip or off-chip data storage, including a processor's L1, L2, or L3 cache or system memory. In at least one embodiment, any portion of code and/or data storage 1105 may be internal or external to one or more processors or other hardware logic devices or circuits. In at least one embodiment, code and/or data storage 1105 may be cache memory, DRAM, SRAM, non-volatile memory (e.g., flash memory), or other storage. In at least one embodiment, a choice of whether code and/or data storage 1105 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1101 and code and/or data storage 1105 may be separate storage structures. In at least one embodiment, code and/or data storage 1101 and code and/or data storage 1105 may be a combined storage structure. In at least one embodiment, code and/or data storage 1101 and code and/or data storage 1105 may be partially combined and partially separate. In at least one embodiment, any portion of code and/or data storage 1101 and code and/or data storage 1105 may be included with other on-chip or off-chip data storage, including a processor's L1, L2, or L3 cache or system memory.

In at least one embodiment, inference and/or training logic 1115 may include, without limitation, one or more arithmetic logic unit(s) (“ALU(s)”) 1110, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1120 that are functions of input/output and/or weight parameter data stored in code and/or data storage 1101 and/or code and/or data storage 1105. In at least one embodiment, activations stored in activation storage 1120 are generated according to linear algebraic and or matrix-based mathematics performed by ALU(s) 1110 in response to performing instructions or other code, wherein weight values stored in code and/or data storage 1105 and/or data storage 1101 are used as operands along with other values, such as bias values, gradient information, momentum values, or other parameters or hyperparameters, any or all of which may be stored in code and/or data storage 1105 or code and/or data storage 1101 or another storage on or off-chip.

In at least one embodiment, ALU(s) 1110 are included within one or more processors or other hardware logic devices or circuits, whereas in another embodiment, ALU(s) 1110 may be external to a processor or other hardware logic device or circuit that uses them (e.g., a co-processor). In at least one embodiment, ALUs 1110 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 1101, code and/or data storage 1105, and activation storage 1120 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1120 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1120 may be cache memory, DRAM, SRAM, non-volatile memory (e.g., flash memory), or other storage. In at least one embodiment, activation storage 1120 may be completely or partially within or external to one or more processors or other logical circuits. In at least one embodiment, a choice of whether activation storage 1120 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1115 illustrated in FIG. 11A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1115 illustrated in FIG. 11A may be used in conjunction with central processing unit (“CPU”) hardware, graphics processing unit (“GPU”) hardware or other hardware, such as field programmable gate arrays (“FPGAs”).

FIG. 11B illustrates inference and/or training logic 1115, according to at least one embodiment. In at least one embodiment, inference and/or training logic 1115 may include, without limitation, hardware logic in which computational resources are dedicated or otherwise exclusively used in conjunction with weight values or other information corresponding to one or more layers of neurons within a neural network. In at least one embodiment, inference and/or training logic 1115 illustrated in FIG. 11B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1115 illustrated in FIG. 11B may be used in conjunction with central processing unit (CPU) hardware, graphics processing unit (GPU) hardware or other hardware, such as field programmable gate arrays (FPGAs). In at least one embodiment, inference and/or training logic 1115 includes, without limitation, code and/or data storage 1101 and code and/or data storage 1105, which may be used to store code (e.g., graph code), weight values and/or other information, including bias values, gradient information, momentum values, and/or other parameter or hyperparameter information. In at least one embodiment illustrated in FIG. 11B, each of code and/or data storage 1101 and code and/or data storage 1105 is associated with a dedicated computational resource, such as computational hardware 1102 and computational hardware 1106, respectively. In at least one embodiment, each of computational hardware 1102 and computational hardware 1106 comprises one or more ALUs that perform mathematical functions, such as linear algebraic functions, only on information stored in code and/or data storage 1101 and code and/or data storage 1105, respectively, result of which is stored in activation storage 1120.

In at least one embodiment, each of code and/or data storage 1101 and 1105 and corresponding computational hardware 1102 and 1106, respectively, correspond to different layers of a neural network, such that resulting activation from one storage/computational pair 1101/1102 of code and/or data storage 1101 and computational hardware 1102 is provided as an input to a next storage/computational pair 1105/1106 of code and/or data storage 1105 and computational hardware 1106, in order to mirror a conceptual organization of a neural network. In at least one embodiment, each of storage/computational pairs 1101/1102 and 1105/1106 may correspond to more than one neural network layer. In at least one embodiment, additional storage/computation pairs (not shown) subsequent to or in parallel with storage/computation pairs 1101/1102 and 1105/1106 may be included in inference and/or training logic 1115.

### Neural Network Training and Deployment

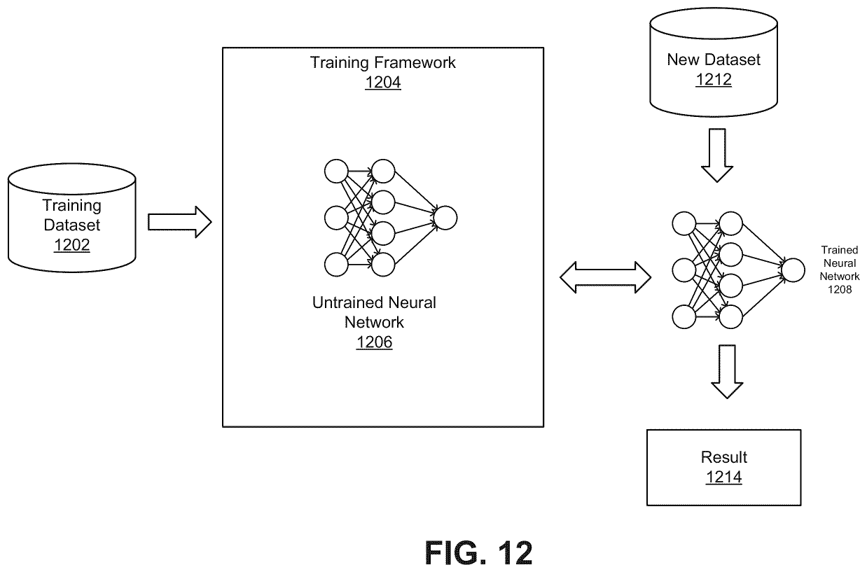

FIG. 12 illustrates training and deployment of a deep neural network, according to at least one embodiment. In at least one embodiment, untrained neural network 1206 is trained using a training dataset 1202. In at least one embodiment, training framework 1204 is a PyTorch framework, whereas in other embodiments, training framework 1204 is a TensorFlow, Boost, Caffe, Microsoft Cognitive Toolkit/CNTK, MXNet, Chainer, Keras, Deeplearning4j, or other training framework. In at least one embodiment, training framework 1204 trains an untrained neural network 1206 and enables it to be trained using processing resources described herein to generate a trained neural network 1208. In at least one embodiment, weights may be chosen randomly or by pre-training using a deep belief network. In at least one embodiment, training may be performed in either a supervised, partially supervised, or unsupervised manner.

In at least one embodiment, untrained neural network 1206 is trained using supervised learning, wherein training dataset 1202 includes an input paired with a desired output for an input, or where training dataset 1202 includes input having a known output and an output of neural network 1206 is manually graded. In at least one embodiment, untrained neural network 1206 is trained in a supervised manner and processes inputs from training dataset 1202 and compares resulting outputs against a set of expected or desired outputs. In at least one embodiment, errors are then propagated back through untrained neural network 1206. In at least one embodiment, training framework 1204 adjusts weights that control untrained neural network 1206. In at least one embodiment, training framework 1204 includes tools to monitor how well untrained neural network 1206 is converging towards a model, such as trained neural network 1208, suitable to generating correct answers, such as in result 1214, based on input data such as a new dataset 1212. In at least one embodiment, training framework 1204 trains untrained neural network 1206 repeatedly while adjust weights to refine an output of untrained neural network 1206 using a loss function and adjustment algorithm, such as stochastic gradient descent. In at least one embodiment, training framework 1204 trains untrained neural network 1206 until untrained neural network 1206 achieves a desired accuracy. In at least one embodiment, trained neural network 1208 can then be deployed to implement any number of machine learning operations.

In at least one embodiment, untrained neural network 1206 is trained using unsupervised learning, wherein untrained neural network 1206 attempts to train itself using unlabeled data. In at least one embodiment, unsupervised learning training dataset 1202 will include input data without any associated output data or “ground truth” data. In at least one embodiment, untrained neural network 1206 can learn groupings within training dataset 1202 and can determine how individual inputs are related to untrained dataset 1202. In at least one embodiment, unsupervised training can be used to generate a self-organizing map in trained neural network 1208 capable of performing operations useful in reducing dimensionality of new dataset 1212. In at least one embodiment, unsupervised training can also be used to perform anomaly detection, which allows identification of data points in new dataset 1212 that deviate from normal patterns of new dataset 1212.

In at least one embodiment, semi-supervised learning may be used, which is a technique in which in training dataset 1202 includes a mix of labeled and unlabeled data. In at least one embodiment, training framework 1204 may be used to perform incremental learning, such as through transferred learning techniques. In at least one embodiment, incremental learning enables trained neural network 1208 to adapt to new dataset 1212 without forgetting knowledge instilled within trained neural network 1208 during initial training.

In at least one embodiment, training framework 1204 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based nucral networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

1. In some embodiments, a method comprises generating, based at least on a user input, a canonical form that comprises a constrained semantic representation of the user input, determining, based at least on the canonical form, a dialog flow that controls output of a language model, and performing one or more operations to execute the dialog flow to generate an output.

2. The method of clause 1, wherein the performing the one or more operations to execute the dialog flow comprises using at least the language model to generate the output.

3. The method of clauses 1 or 2, further comprising generating a second canonical form based at least on the output, determining a second dialog flow based at least on the second canonical form, and performing one or more second operations to execute the second dialog flow to generate a second output.

4. The method of any of clauses 1-3, wherein the generating the canonical form comprises generating an embedding of the user input in a semantic or latent space, determining one or more example user inputs that are associated with one or more predefined canonical forms based at least on the embedding of the user input and one or more embeddings of the one or more example user inputs in the semantic or latent space, generating a prompt that includes the one or more example user inputs, the one or more predefined canonical forms, and at least a portion of a current conversation, and processing the prompt using the language model to generate the canonical form.

5. The method of any of clauses 1-4, wherein the generating the canonical form comprises processing the user input using a trained machine learning model.

6. The method of any of clauses 1-5, wherein the determining the dialog flow comprises matching the canonical form to a predefined canonical form associated with the dialog flow.

7. The method of any of clauses 1-6, wherein the determining the dialog flow comprises generating the dialog flow based at least on the canonical form.

8. The method of any of clauses 1-7, wherein the determining the dialog flow comprises generating an embedding of the canonical form in a semantic or latent space, determining one or more canonical forms that are associated with one or more predefined dialog flows based at least on the embedding of the canonical form and one or more embeddings of the one or more canonical forms in the semantic or latent space, generating a prompt that includes the one or more canonical forms, the one or more predefined dialog flows, and at least a portion of a current conversation, and processing the prompt using the language model to generate the dialog flow.

9. The method of any of clauses 1-8, wherein the performing the one or more operations to execute the dialog flow comprises generating an embedding of a second canonical form associated with the dialog flow in a semantic or latent space, determining one or more canonical forms based at least on the embedding of the second canonical form and one or more embeddings of the one or more predefined canonical forms in the semantic or latent space, generating a prompt that includes the one or more canonical forms, one or more example outputs associated with the canonical forms, and at least a portion of a current conversation, and processing the prompt using the language model to generate the output.

10. The method of any of clauses 1-9, wherein the canonical form and the dialog flow are specified in a formal modeling language.

11. In some embodiments, a processor comprises one or more processing units to perform operations comprising generating, based at least on a user input, a canonical form that comprises a constrained semantic representation of the user input, determining, based at least on the canonical form, a dialog flow that controls output of a language model, and performing one or more operations to execute the dialog flow to generate an output.

12. The processor of clause 11, wherein the performing the one or more operations to execute the dialog flow comprises using at least the language model to generate the output.

13. The processor of clauses 11 or 12, wherein the one or more processing units further perform operations comprising generating a second canonical form based at least on the output, determining a second dialog flow based at least on the second canonical form, and performing one or more second operations to execute the dialog flow to generate a second output.

14. The processor of any of clauses 11-13, wherein the generating the canonical form comprises generating an embedding of the user input in a semantic or latent space, determining one or more example user inputs that are associated with one or more predefined canonical forms based at least on the embedding of the user input and one or more embeddings of the one or more example user inputs in the semantic or latent space, generating a prompt that includes the one or more example user inputs, the one or more predefined canonical forms, and at least a portion of a current conversation, and processing the prompt using the language model to generate the canonical form.

15. The processor of any of clauses 11-14, wherein the determining the dialog flow comprises generating an embedding of the canonical form in a semantic or latent space, determining one or more canonical forms that are associated with one or more predefined dialog flows based at least on the embedding of the canonical form and one or more embeddings of the one or more canonical forms in the semantic or latent space, generating a prompt that includes the one or more canonical forms, the one or more predefined dialog flows, and at least a portion of a current conversation, and processing the prompt using the language model to generate the dialog flow.

16. The processor of any of clauses 11-15, wherein the performing the one or more operations to execute the dialog flow comprises generating an embedding of a second canonical form associated with the dialog flow in a semantic or latent space, determining one or more canonical forms based at least on the embedding of the second canonical form and one or more embeddings of the one or more predefined canonical forms in the semantic or latent space, generating a prompt that includes the one or more canonical forms, one or more example outputs associated with the canonical forms, and at least a portion of a current conversation, and inputting the prompt into the language model to generate the output.

17. The processor of any of clauses 11-16, wherein the performing the one or more operations to execute the dialog flow further comprises accessing at least one of a knowledge base, a computational knowledge engine, a search engines, or an automation service to generate a second output, wherein the prompt is further generated to include at least a portion of the second output.

18. The processor of any of clauses 11-17, wherein the processor is comprised in at least one of an infotainment system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using a robot, a system for generating or presenting virtual reality, augmented reality, or mixed reality content, a system for performing conversational AI operations, a system implementing one or more large language models (LLMs), a system for generating synthetic data, a system incorporating one or more virtual machines (VMs), a system implemented at least partially in a data center, or a system implemented at least partially using cloud computing resources.

19. In some embodiments, a system comprises one or more processors to execute a dialog engine to manage an interplay between a large language model (LLM) and one or more user inputs, the dialog engine dynamically generating a prompt for the LLM including one or more example dialog flows associated with one or more predefined user inputs that are within a threshold similarity to the one or more user inputs.

20. The system of clause 19, wherein the prompt is dynamically generated based at least on the one or more user inputs being dissimilar from the one or more predefined user inputs by more than a threshold amount.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating, based at least on a user input, a canonical form that comprises a constrained semantic representation of the user input;
determining, based at least on the canonical form, a dialog flow that controls output of a language model; and
performing one or more operations to execute the dialog flow to generate an output.

2. The method of claim 1, wherein the performing the one or more operations to execute the dialog flow comprises using at least the language model to generate the output.

3. The method of claim 1, further comprising:
generating a second canonical form based at least on the output;
determining a second dialog flow based at least on the second canonical form; and
performing one or more second operations to execute the second dialog flow to generate a second output.

4. The method of claim 1, wherein the generating the canonical form comprises:
generating an embedding of the user input in a semantic or latent space;
determining one or more example user inputs that are associated with one or more predefined canonical forms based at least on the embedding of the user input and one or more embeddings of the one or more example user inputs in the semantic or latent space;
generating a prompt that includes the one or more example user inputs, the one or more predefined canonical forms, and at least a portion of a current conversation; and
processing the prompt using the language model to generate the canonical form.

5. The method of claim 1, wherein the generating the canonical form comprises processing the user input using a trained machine learning model.

6. The method of claim 1, wherein the determining the dialog flow comprises matching the canonical form to a predefined canonical form associated with the dialog flow.

7. The method of claim 1, wherein the determining the dialog flow comprises generating the dialog flow based at least on the canonical form.

8. The method of claim 1, wherein the determining the dialog flow comprises:
generating an embedding of the canonical form in a semantic or latent space;
determining one or more canonical forms that are associated with one or more predefined dialog flows based at least on the embedding of the canonical form and one or more embeddings of the one or more canonical forms in the semantic or latent space;
generating a prompt that includes the one or more canonical forms, the one or more predefined dialog flows, and at least a portion of a current conversation; and
processing the prompt using the language model to generate the dialog flow.

9. The method of claim 1, wherein the performing the one or more operations to execute the dialog flow comprises:
generating an embedding of a second canonical form associated with the dialog flow in a semantic or latent space;
determining one or more canonical forms based at least on the embedding of the second canonical form and one or more embeddings of the one or more predefined canonical forms in the semantic or latent space;
generating a prompt that includes the one or more canonical forms, one or more example outputs associated with the canonical forms, and at least a portion of a current conversation; and
processing the prompt using the language model to generate the output.

10. The method of claim 1, wherein the canonical form and the dialog flow are specified in a formal modeling language.

11. A processor comprising:
one or more processing units to perform operations comprising:
generating, based at least on a user input, a canonical form that comprises a constrained semantic representation of the user input;
determining, based at least on the canonical form, a dialog flow that controls output of a language model; and
performing one or more operations to execute the dialog flow to generate an output.

12. The processor of claim 11, wherein the performing the one or more operations to execute the dialog flow comprises using at least the language model to generate the output.

13. The processor of claim 11, wherein the one or more processing units further perform operations comprising:
generating a second canonical form based at least on the output;
determining a second dialog flow based at least on the second canonical form; and
performing one or more second operations to execute the dialog flow to generate a second output.

14. The processor of claim 11, wherein the generating the canonical form comprises:
generating an embedding of the user input in a semantic or latent space;
determining one or more example user inputs that are associated with one or more predefined canonical forms based at least on the embedding of the user input and one or more embeddings of the one or more example user inputs in the semantic or latent space;
generating a prompt that includes the one or more example user inputs, the one or more predefined canonical forms, and at least a portion of a current conversation; and
processing the prompt using the language model to generate the canonical form.

15. The processor of claim 11, wherein the determining the dialog flow comprises:
generating an embedding of the canonical form in a semantic or latent space;
determining one or more canonical forms that are associated with one or more predefined dialog flows based at least on the embedding of the canonical form and one or more embeddings of the one or more canonical forms in the semantic or latent space;
generating a prompt that includes the one or more canonical forms, the one or more predefined dialog flows, and at least a portion of a current conversation; and
processing the prompt using the language model to generate the dialog flow.

16. The processor of claim 11, wherein the performing the one or more operations to execute the dialog flow comprises:
generating an embedding of a second canonical form associated with the dialog flow in a semantic or latent space;
determining one or more canonical forms based at least on the embedding of the second canonical form and one or more embeddings of the one or more predefined canonical forms in the semantic or latent space;
generating a prompt that includes the one or more canonical forms, one or more example outputs associated with the canonical forms, and at least a portion of a current conversation; and
inputting the prompt into the language model to generate the output.

17. The processor of claim 16, wherein the performing the one or more operations to execute the dialog flow further comprises:
accessing at least one of a knowledge base, a computational knowledge engine, a search engines, or an automation service to generate a second output,
wherein the prompt is further generated to include at least a portion of the second output.

18. The processor of claim 11, wherein the processor is comprised in at least one of:
an infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for generating or presenting virtual reality, augmented reality, or mixed reality content;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. A system comprising:
one or more processors to:
execute a dialog engine to manage an interplay between a large language model (LLM) and one or more user inputs, the dialog engine dynamically generating a prompt for the LLM including one or more example dialog flows associated with one or more predefined user inputs that are within a threshold similarity to the one or more user inputs.

20. The system of claim 19, wherein the prompt is dynamically generated based at least on the one or more user inputs being dissimilar from the one or more predefined user inputs by more than a threshold amount.
